(19) United States
(12) Patent Application Publication
(10) Pub. No.: US 2024/0385083 A1
(43) Pub. Date: Nov. 21, 2024

(54) MANUFACTURING PROCESS AND MACHINE TOOL

(71) Applicant: TRUMPF Werkzeugmaschinen SE + Co. KG, Ditzingen (DE)

(72) Inventors: Thomas Kieweler, Wimsheim (DE); Florian Lachner, Leutenbach (DE); Marcus Hagner, Pleidelsheim (DE)

(21) Appl. No.: 18/786,628

(22) Filed: Jul. 29, 2024

Related U.S. Application Data
(63) Continuation of application No. PCT/EP2023/050998, filed on Jan. 17, 2023.

(30) Foreign Application Priority Data
Feb. 15, 2022 (DE) 10 2022 103 484.4

(51) Int. Cl. G01M 99/00; B23K 26/38

(52) U.S. Cl. CPC G01M 99/005; B23K 26/38

(57) ABSTRACT

A method of manufacturing includes machining a workpiece with a machine tool. A plurality of size classes are predefined for at least one stress parameter of the machine tool. The method includes, during the machining: A) measuring at least one operating parameter of the machine tool; B) calculating the at least one stress parameter from the at least one measured operating parameter; and C) storing a number of times the at least one stress parameter is within each of the size classes.

### CROSS REFERENCE TO RELATED APPLICATIONS

This application is a continuation of International Application No. PCT/EP2023/050998 (WO 2023/156110 A1), filed on Jan. 17, 2023, and claims benefit to German Patent Application No. DE 10 2022 103 484.4, filed on Feb. 15, 2022. The aforementioned applications are hereby incorporated by reference herein.

### FIELD

The present disclosure relates to a manufacturing process in which a workpiece is machined with a machine tool.

### BACKGROUND

During the service life of a machine tool, a wide variety of forms of loads and consumption occur due to its use. Operating parameters that are related to these loads and consumption can basically be measured and recorded with sensors. However, during long periods of use, this requires significant memory, especially if the relevant operating parameters change quickly. In addition, the immediate storage of the operating parameters can allow reconstruction of the machining operations performed. Users of the machine tool will therefore not want to make these raw data available to a maintenance service provider or machine manufacturer on a regular basis.

In principle, it is conceivable to calculate the loads and consumption using models based on the machining operations carried out with the operating parameters measured in the process. However, subsequent generation of theoretical curves of the loads and consumption often only partially depicts reality, since the real curves can be influenced by random variables and in particular the wear of the machine tool.

DE 10 2018 007 905 A1 describes a process for recording and monitoring the history of a working spindle, for which the following data are recorded without loss: the identification data relating to the working spindle, the revision statuses of the software and hardware, the parameter data relating to the installed sensors, the pure process data and/or the maximum and minimum values that have been filtered out as well as the diagnostic data relating to all sensors. The process data describe the temporal progression of the sensor characteristic variables.

A welding or cutting system with a torch is known from DE 20 2016 001 105 U1 mentioned at the outset. Communication takes place between the torch and a power supply or control system. The control system monitors and tracks the use of the torch and its respective components. The control system then uses this information to inform a user of the remaining service life or an imminent failure of a torch component. A monitoring apparatus may include at least one accumulator for totalizing a first torch usage factor based on a selected welding parameter or a selected combination of parameters. The accumulator has an output signal that represents the sum of the main parameters. When a monitored torch usage factor reaches a certain value, an action signal is generated.

### SUMMARY

In an embodiment, the present disclosure provides a method of manufacturing that includes machining a workpiece with a machine tool. A plurality of size classes are predefined for at least one stress parameter of the machine tool. The method includes, during the machining: A) measuring at least one operating parameter of the machine tool; B) calculating the at least one stress parameter from the at least one measured operating parameter; and C) storing a number of times the at least one stress parameter is within each of the size classes.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of a machine tool according to an aspect of the present disclosure;

FIG. 2 shows a schematic flowchart of a manufacturing process according to an aspect of the present disclosure;

FIG. 3 shows an exemplary representation of the course of the path and acceleration of a tool of the machine tool during machining plotted against time; and

FIG. 4 shows a schematic representation of event frequencies (numbers) of the values from FIG. 3 divided into multi-dimensional size classes.

### DETAILED DESCRIPTION

The present disclosure relates to a manufacturing process in which a workpiece is machined with a machine tool, with at least one operating parameter of the machine tool being measured during machining. The present disclosure further relates to a machine tool with a tool for machining a workpiece and with a sensor device for capturing at least one operating parameter during the machining of the workpiece with the tool.

Aspects of the present disclosure make it possible to efficiently assess the stress on a machine tool.

An aspect of the present disclosure provides a manufacturing process in which a workpiece is machined with a machine tool. The machine tool can be used for sheet metal machining; in other words, it can be a sheet metal machining process. During machining, the workpiece can be cut out from a blank, for example a sheet metal panel. The machine tool may be in particular a laser machining machine, for example a laser cutting machine or a laser welding machine. During machining, a laser cutting operation or a laser welding operation can be performed. Alternatively, the machine tool can be a punching machine, for example.

The manufacturing process according to the present disclosure is preferably carried out with a machine tool according to the exemplary process that is described below.

During machining, at least one operating parameter of the machine tool is measured in a step A). At least two, particularly preferably at least three, operating parameters are preferably measured. The machine tool can have a sensor device for this purpose. The at least one operating parameter can describe in particular a state currently present during ongoing machining.

For example, the at least one operating parameter may be selected from:
position, in particular of a tool of the machine tool, in particular along a machine axis of the machine tool,
acceleration, in particular of the tool, in particular along the machine axis,
power consumption, force and/or torque of a drive, in particular of the machine axis,
machining force of the tool of the machine tool,
power output of the tool of the machine tool, in particular laser power of a laser machining head,
pressure and/or volume flow of a process gas,
time increment over which another operating parameter assumes a certain value,
temperature, in particular of a tool of the machine tool, and/or
scattered light, in particular intensity of the scattered light reflected by the workpiece.

According to an aspect of the present disclosure, a plurality of size classes are predefined for at least one stress parameter of the machine tool. The size classes make it possible to classify and easily record the operations relevant to the stress on the machine tool.

During the machining of the workpiece, at least one stress parameter is calculated from the at least one measured operating parameter in a step B). In the simplest case, the stress parameter can correspond to the operating parameter. The stress parameter can be calculated by weighting the values of the operating parameter.

In addition, during the machining of the workpiece, a number of times the at least one stress parameter is within each of the size classes is stored in a step C). In other words, the number of times the stress parameter assumes a value that falls within the predefined size classes is counted. The memory requirements are therefore determined by the number of stress parameters and the number of size classes. In particular, the memory requirements do not increase (or at most insignificantly) with increasing machining time, since only the numbers (numerical values) stored for the different size classes change, but generally no new values are added.

The stored number of stresses falling into a size class allows an analysis and assessment of the stress on the machine tool. This creates a history over the life of a machine tool that can be used for other applications. The stored information can be used, for example, for diagnostic purposes, in particular for detecting components at risk of wear, for controlling maintenance measures as well as for controlling further machining operations. The aggregated storage of the stress events, which differ according to size classes, simplifies the storage itself, on the one hand, and simplifies the evaluation, on the other hand. In addition, the situation in which the stored data can be used to draw conclusions about the machining operations specifically carried out is avoided.

Preferably, the at least one stress parameter is calculated from at least two operating parameters, in particular by multiplication or division. This allows a more detailed assessment of the stresses on the machine.

Particularly preferably, the at least one stress parameter is calculated with the duration over which a respective operating parameter has been measured. In particular, the at least one operating parameter can be multiplied by a corresponding time increment, over which it assumed a certain value, or can be divided by the time increment. The former allows, in particular, the determination of consumption data in the sense of an integration over time. For example, a laser power can be used in this manner to determine an energy input that can represent a load on a tool support, such as a support bar. The latter allows, in particular, the determination of performance data which can be used for a wear analysis.

Preferably at least two, particularly preferably at least three, stress parameters are calculated. The analysis of the stress can thus be further refined.

Particularly preferably, the at least two stress parameters are calculated for the same times and are assigned to a size class for the plurality of stress parameters. The treatment is thus recorded and analyzed in a multi-dimensional grid, wherein a size class is limited by two parameter values of each of the stress parameters considered. In this way, the stresses that occur, for example mechanical loads and/or consumption, can be recorded and analyzed in their respective physical context. In particular, dependencies between a plurality of operating parameters or a plurality of stress parameters can thereby be taken into account or detected.

Steps B) and C) and preferably also A) can be carried out at a specified frequency. The frequency is preferably at least 10 Hz, particularly preferably at least 100 Hz, very particularly preferably at least 500 Hz. In this way, fast-changing operations, which can take place in fractions of seconds, for example, during laser machining, can also be precisely recorded and further processed efficiently by way of the classification and aggregation.

The size classes for the at least one stress parameter or at least one of the stress parameters can each comprise the same range of values. In other words, the size classes can be evenly distributed. This is useful if the stress parameter or underlying operating parameter is not directly related to mechanical structures of the machine tool.

Alternatively or additionally, the size classes for the at least one stress parameter or at least one of the stress parameters may comprise different ranges of values. The classification of the determined values of the stress parameter can thus be adapted, for example, to mechanical structures of the machine tool. In particular, size classes with larger and smaller ranges of values can alternately follow each other. In this way, for example, the sequence of support bars of a workpiece support and intermediate gaps can be tracked in order to detect the stress on the support bars, for example by the input of laser radiation.

Step C) can be carried out over a period of use of the machine tool. In other words, the stress events within the respective size classes are counted over the entire period of use of the machine tool. In this way, the stress on the machine tool can be assessed over its service life. This variant is particularly suitable for diagnosing machine wear and for planning maintenance and repair measures.

Alternatively or additionally, it can be provided that step C) is carried out again in each case for a further blank, a further workpiece or a further machined contour. In other words, the stress events within the respective size classes are counted for the machining of the respective blank, workpiece or contour. In this way, loads and/or consumption can be recorded and evaluated in a machining-related manner. This makes it possible to assign wear-related and/or consumption-dependent machining costs to the respective blank, workpiece or contour.

It may be provided that at least one component of the machine tool is serviced, repaired and/or replaced if the numbers determined in step C) satisfy a predefined criterion. The above-mentioned measures can therefore be taken on the basis of use and, in particular as a preventive measure, on the basis of the load and/or consumption data recorded.

Alternatively or additionally, it can be provided that the numbers determined in step C) are used to machine further workpieces, in particular to determine their arrangement and/or orientation in the working space of the machine tool. The further workpieces can be arranged and/or oriented in particular in such a way that regions that are difficult to machine, for example contours that need to be machined in a particularly precise manner, are placed in regions of the working space that previously had a lower load or were less worn. Furthermore, the stress on the machine tool can be evenly distributed in the working space by appropriately arranging or orienting the further workpieces in order to increase the service life of the machine tool.

An aspect of the present disclosure also includes a machine tool, in particular a laser machining machine, having:
a tool for machining a workpiece,
a sensor device for measuring at least one operating parameter during the machining of the workpiece with the tool, and
a control device which is configured to carry out a method as claimed in any one of the preceding claims.

The machine tool implemented according to aspects of the present disclosure makes it possible to carry out the above-described manufacturing process. The machine tool typically has at least one machine axis for moving the tool relative to the workpiece. The sensor device can comprise one or more sensors. The control device can be arranged locally on the machine tool. Alternatively, the control device may be designed independently of the machine tool and may be configured in particular to control a plurality of machine tools.

Further features and advantages of the present disclosure emerge from the description, the claims and the drawing. According to the present disclosure, the features mentioned above and those still to be further presented can be used in each case individually or together in any desired expedient combinations. The embodiments shown and described should not to be understood as an exhaustive list, but rather are of an exemplary character for describing the present disclosure.

### DETAILED DESCRIPTION

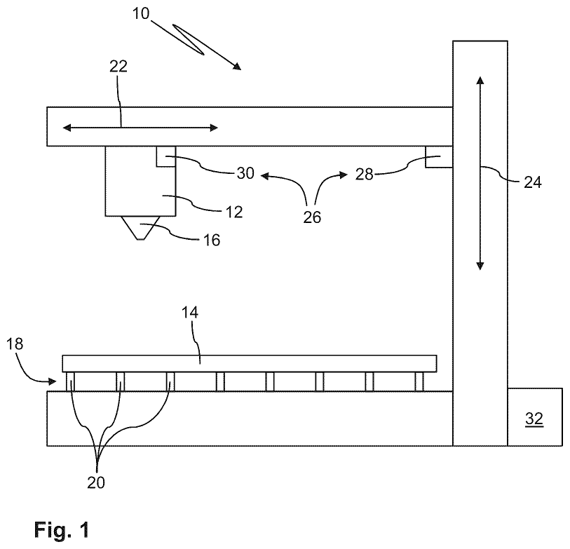

FIG. 1 shows an exemplary embodiment of a machine tool 10 implemented according to an aspect of the present disclosure. The machine tool 10 is, by way of example here, a laser machining machine, in particular a laser cutting machine. The machine tool 10 has a tool 12, in this case a laser machining head. When machining a workpiece 14, a laser beam that is not represented in any more detail, together with a process gas, can emerge from a nozzle 16. The workpiece 14 is arranged on a workpiece support 18 having a plurality of support bars 20. The tool 12 can be moved along a plurality of machine axes 22, 24 relative to the workpiece 14.

The machine tool 10 has a sensor device 26 with a plurality of sensors 28, 30 for capturing operating parameters during the machining of the workpiece 14. One or more sensors 28 can measure, for example, the position, speed and/or acceleration of the tool 12 along the machine axes 22, 24. One or more sensors 30 can measure, for example, a power output and/or a temperature of the tool 12. It goes without saying that further sensors for measuring further operating parameters may be provided.

The machine tool 10 further has a control device 32. The control device 32 is configured to control the machining of the workpiece 14 with the tool 12 and to process the measured values from the sensor device 26.

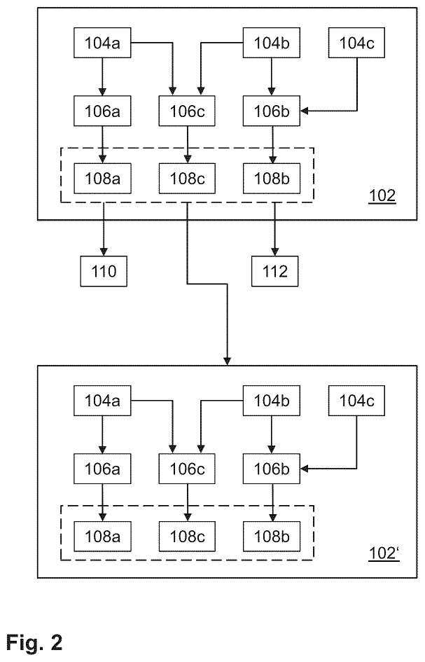

FIG. 2 shows a schematic flowchart of the machining of the workpiece 14 with the machine tool 10. In a step 102, the workpiece 14 is machined with the tool 12. Here, the workpiece 14 is cut by the laser beam.

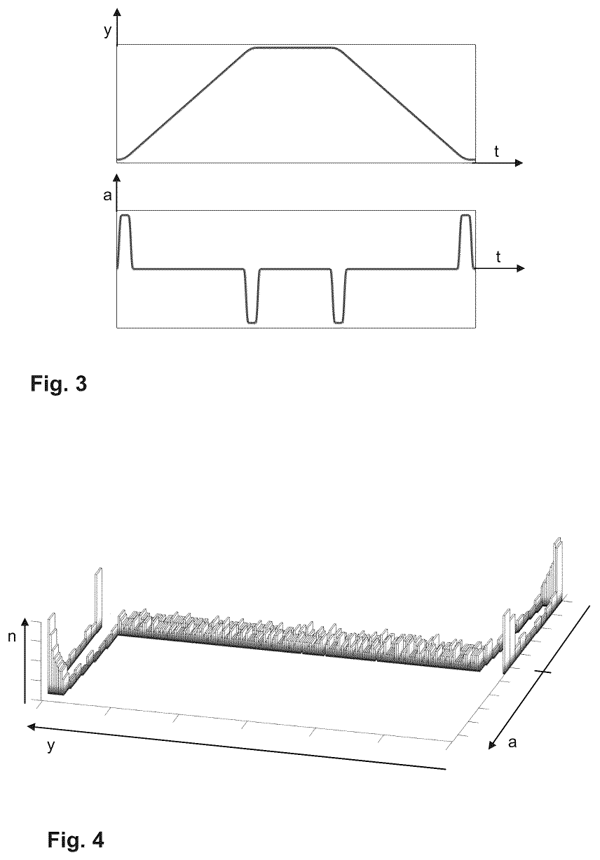

During the machining of the workpiece 14, a plurality of operating parameters are measured by the sensor device in steps 104a, 104b, 104c, for example a position y of the tool 12 along one of the machine axes and the acceleration a of the tool 12 along this machine axis, compare FIG. 3. The different operating parameters can be measured at a specified frequency, for example 1000 Hz. Preferably, all operating parameters are measured at the same times in each case. A further operating parameter can be a duration over which another operating parameter assumed a certain value. This duration can correspond to the inverse of the measurement frequency.

A plurality of stress parameters are calculated from the measured operating parameters during machining 102 in steps 106a, 106b, 106c. In the simplest case, a stress parameter can correspond to an operating parameter. However, a plurality of operating parameters can also be calculated together in a predefined manner in order to obtain a stress parameter.

Size classes are predefined for the stress parameters. Preferably, a size class is limited in each case by pairs of values of a plurality of stress parameters. In other words, the size classes can be multi-dimensional. The pairs of values can comprise the same or different ranges of values (for a respective stress parameter). Different ranges of values can reproduce, for example, the grid of support bars 20 and intermediate gaps of the workpiece support 18, in particular if the relevant stress parameter is related to the position of the tool 12 along the machine axis 22 or describes this position.

Then, during machining 102, the calculated values of the operating parameters are divided into the predefined size classes in steps 108a, 108b, 108c. In other words, the number of times the operating parameters assume a value within the different size classes is counted. In FIG. 4, the corresponding numbers n for movements of the tool 12 according to FIG. 3 are plotted against the underlying operating or stress parameters, in this case position y and acceleration a. This number is stored for all predefined size classes.

On the one hand, these numbers can be determined for the machine tool 10 over its entire service life. On the other hand, these numbers can be determined in a machining-related manner, for example for the machining of the one workpiece 14.

Machining-related costs, consumption and/or wear data can be determined from the workpiece-related numbers in a step 110. These can in turn be used for invoicing or costing.

Maintenance measures for the machine tool 10 can be derived from the service-life-related numbers in a step 112. For example, components of the machine tool 10 can be serviced or replaced if the numbers in the different size classes of the stress parameters satisfy predefined criteria.

The service-life-related numbers can be used particularly advantageously to control the machining of further workpieces in steps 102′. The further workpieces can be arranged and oriented in particular in the working space of the machine tool 10 in such a way that the loads on the machine tool 10 are evenly distributed. This can ensure, for example, that the machine axis 22, 24 and its drives wear evenly. Alternatively or additionally, the further workpieces can be arranged and oriented in the working space of the machine tool 10 such that regions of the workpieces that are difficult to machine, for example with particularly tight tolerances or high dynamic requirements for the machine tool 10, are located in those regions of the working space that previously were subject to less stress and therefore less wear.

Aspects of the present disclosure relate, in particular, to a manufacturing process in which stress parameters are recorded in a multi-dimensional grid and divided into size classes. Event frequencies are determined in the process. In other words, the number of times the stress parameters assume a value within the different size classes is counted. Counting can extend over an entire period of use of the machine tool or individual machining operations or partial machining operations. The stress parameters can describe load, wear and/or consumption variables. The stress parameters can be measured directly or derived from measured operating parameters. Maintenance measures and/or further machining operations can be controlled by evaluating the determined numbers in the size classes. In particular, the maintenance measures and/or further machining operations can be carried out depending on the determined numbers. In particular, the manufacturing process according to the present disclosure enables context-related recording and analysis of the machining operations carried out with low memory requirements, and without the machining operations specifically carried out being able to be reconstructed from the stored numbers.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

Machine tool 10
Tool 12
Workpiece 14
Nozzle 16
Workpiece support 18
Support bars 20
Machine axes 22, 24
Sensor device 26
Sensors 28, 30
Control device 32
Position y
Acceleration a
Number n
Machine 102, 102′
Measure 104a, 104b, 104c operating parameters
Calculate 106a, 106b, 106c stress parameters
Determine 108a, 108b, 108c numbers for size classes of the stress parameters
Determine 110 machining-related data
Perform 112 maintenance measures

1. A method of manufacturing, the method comprising:
machining a workpiece with a machine tool,
wherein a plurality of size classes are predefined for at least one stress parameter of the machine tool,
wherein the method further comprises, during the machining:
A) measuring at least one operating parameter of the machine tool;
B) calculating the at least one stress parameter from the at least one measured operating parameter; and
C) storing a number of times the at least one stress parameter is within each of the size classes.

2. The method as claimed in claim 1, wherein in step A, the measuring of the at least one operating parameter comprises measuring at least two operating parameters.

3. The method as claimed in claim 2, wherein in step B, the at least one stress parameter is calculated from the at least two operating parameters.

4. The method as claimed in claim 1, wherein in step B, the at least one stress parameter is calculated with a duration over which the at least one operating parameter has been measured.

5. The method as claimed in claim 1, wherein in step B, calculating the at least one stress parameter comprises calculating at least two stress parameters.

6. The method as claimed in claim 5, wherein in step B, the at least two stress parameters are calculated for same times and are assigned to a size class for the plurality of stress parameters.

7. The method as claimed in claim 1, wherein steps B) and C) are carried out at a specified frequency.

8. The method as claimed in claim 1, wherein the size classes for the at least one stress parameter each comprise a same range of values.

9. The method as claimed in claim 1, wherein the size classes for the at least one stress parameter comprise different ranges of values, such that size classes with larger and smaller ranges of values alternately follow each other.

10. The method as claimed in claim 1, wherein step C) is carried out over a period of use of the machine tool.

11. The method as claimed in claim 1, wherein step C) is carried out again in each case for a further blank, a further workpiece or a further machined contour.

12. The method as claimed in claim 1, wherein the machine tool is a laser machining machine, and wherein the machining comprises a laser cutting process or a laser welding process.

13. The method as claimed in claim 1, wherein the at least one operating parameter is selected from:
a position of a tool of the machine tool, along a machine axis of the machine tool,
an acceleration of the tool along the machine axis,
a power consumption, a force, and/or a torque of a drive of the machine axis,
a machining force of the tool of the machine tool,
a power output of the tool of the machine tool, which is a laser power of a laser machining head,
a pressure and/or volume flow of a process gas,
a time increment over which another operating parameter assumes a certain value,
a temperature of the a tool of the machine tool, and/or scattered light.

14. The method as claimed in claim 1, wherein at least one component of the machine tool is serviced, repaired, and/or replaced based on the numbers determined in step C) satisfying a predefined criterion.

15. The method as claimed in claim 1, wherein the numbers determined in step C) are used to machine further workpieces, to determine their arrangement and/or orientation in the working space of the machine tool.

16. A machine tool comprising a laser machining machine, which comprises:
a tool configured to machine a workpiece;
a sensor configured to measure at least one operating parameter during the machining of the workpiece with the tool, and
a control device which is configured to carry out the method as claimed in claim 1.
